(19) United States
(12) Patent Application Publication
(10) Pub. No.: US 2011/0064911 A1
(43) Pub. Date: Mar. 17, 2011

(54) SOFT CUSHION STRUCTURE

(76) Inventor: CHUN-FU KUO, TAICHUNG HSIEN (TW)

(21) Appl. No.: 12/558,071

(22) Filed: Sep. 11, 2009

(51) Int. Cl. B32B 3/10

(52) U.S. Cl. 428/131

(57) ABSTRACT

A soft cushion structure of the present invention includes a soft foaming resilient supportive body and a soft elastomer. The soft foaming resilient supportive body has one or more penetrating holes which communicate upper and under gel rooms disposed on the soft foaming resilient supportive body. The soft elastomer is filled in the holes and at least a part of the upper and under gel rooms respectively, so as to combine the soft elastomer with the soft foaming resilient supportive body to form a composite structure.

### BACKGROUND OF THE INVENTION

1. Field of the Invention

The present invention relates to a soft cushion structure substantially consists of a soft foaming resilient supportive body and a soft elastomer.

2. Description of the Prior Art

A cushion structure is well discussed, such as disclosed in U.S. Pat. No. 4,654,983 and U.S. Pat. No. 5,367,792. The '983 patent discloses a sole construction including a shell and a core encapsulated within the shell. The core is made of low density PU or EVA, and the shell is made of high density PU. On the other hand, the '792 patent discloses a shoe sole construction including a shell, made of polyester elastomer, PU or EVE, and a filler, such as air, fluid or synthetic foam, stuffed in the shell.

The common features of the above mentioned cushion structure is that the core (or filler) thereof is less supportive than the shell. That is, the core is mainly stuffed in the shell to elevate the property of shock absorption and cushioning. Furthermore, the shell substantially encapsulates the core such that the interaction between different parts of the cushion structure is insufficient so that the increase in cushioning property is limited. Moreover, such constructions are mainly softer in the middle and harder in the periphery, which may not satisfy the consumers' needs.

In addition, the shell of such constructions is made of high density PU or polyester elastomer and the filler thereof is made of single material. Therefore, the reduction in total weight of the construction is limited as well.

### SUMMARY OF THE INVENTION

The main object of the present invention is to provide a cushion structure including a soft foaming resilient supportive body as the main supportive part thereof.

The other object of the present invention is to provide a cushion structure with upper and under gel rooms communicated by one or more penetrating holes for a soft elastomer to fill therein.

To achieve the above object, a soft cushion structure of the present invention includes a soft foaming resilient supportive body and a soft elastomer. The soft foaming resilient supportive body has one or more penetrating holes which communicate upper and under gel rooms disposed on the soft foaming resilient supportive body. The soft elastomer is filled in the holes and at least a part of the upper and under gel rooms respectively, so as to combine the soft elastomer with the soft foaming resilient supportive body to form a composite structure.

Wherein, the soft foaming resilient supportive body is compressible, deformable and elastic recoverable, the soft elastomer is deformable and elastic recoverable, but the soft elastomer is substantially incompressible.

As a result, the soft foaming resilient supportive body provides better supporting property and has the property of undergoing a compression strain, while the soft elastomer filled in the upper and under gel rooms has the property of undergoing a slightly flowing strain. Due to the stress-strain compensation mechanisms provided by the soft foaming resilient supportive body and the soft elastomer respectively, the stress applied on the soft cushion structure can be efficiently distributed outward and thus released to resolve the stress concentration problem, so as to further enhance the comfort performance which satisfies the consumer's need. In comparison to a cushion structure that mainly consists of the soft elastomer, the present soft cushion structure further utilizing the soft foaming resilient supportive body, which has the property of undergoing the compression strain that can co-act with the slightly-flowing-strain property of the soft elastomer, has the elevated stress releasing property. In addition, the consumption of the expensive soft elastomer is significantly decreased because a part of the soft elastomer is replaced by the cheaper and lighter soft foaming resilient supportive body, resulting in the reduction in material cost and total weight of the soft cushion structure.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a pictorial drawing showing a soft cushion structure in accordance with a first embodiment of the present invention;

FIG. 2 is a plan view of a soft cushion structure in accordance with a first embodiment of the present invention;

FIG. 3 is a pictorial drawing showing a soft foaming resilient supportive body in accordance with a first embodiment of the present invention;

FIG. 4 is a profile of a soft cushion structure in accordance with a first embodiment of the present invention;

FIG. 5 is a profile showing a soft cushion structure under pressure in accordance with a first embodiment of the present invention;

FIG. 6 is a plan view of a soft cushion structure in accordance with a second embodiment of the present invention;

FIG. 7 is a profile of a soft cushion structure in accordance with a second embodiment of the present invention;

FIG. 7A is a partial enlarged drawing of FIG. 7;

FIG. 8 is a profile of a soft cushion structure in accordance with a third embodiment of the present invention;

FIG. 9 is a profile showing a soft cushion structure under pressure in accordance with a third embodiment of the present invention.

### DETAILED DESCRIPTION OF THE PREFERRED EMBODIMENTS

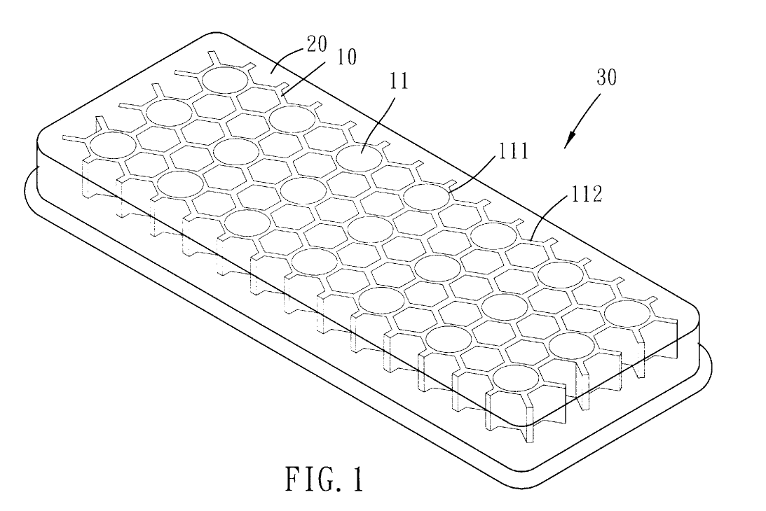

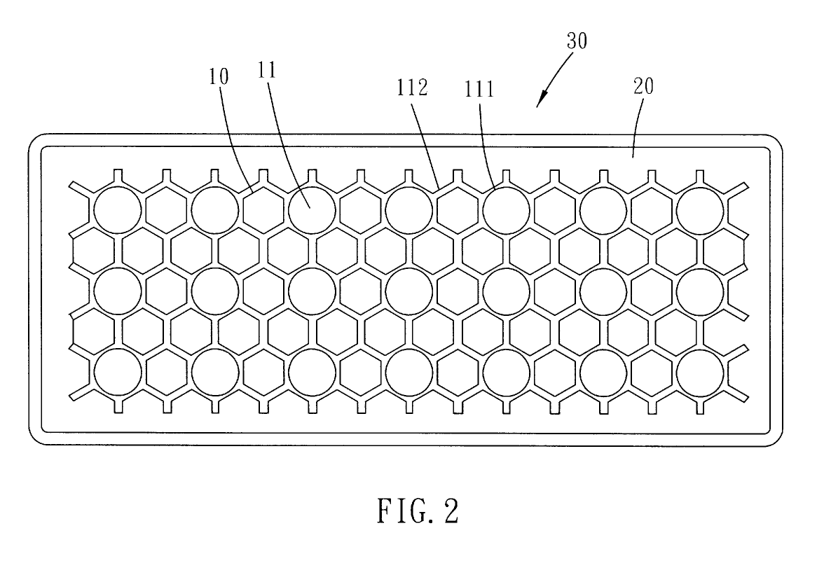

Please refer to FIGS. 1 to 4 for a first embodiment of the present invention. A soft cushion structure includes a soft foaming resilient supportive body 10 and a soft elastomer 20 which is combined with the supportive body 10 to form a composite structure 30.

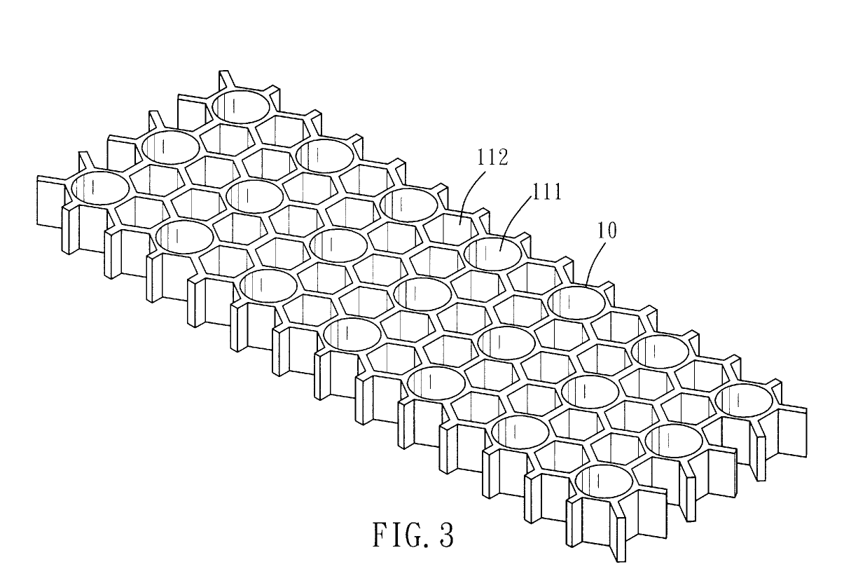

The soft foaming resilient supportive body 10 has one or more penetrating holes 11. More particularly, the holes 11 penetrate the supportive body 10 along the direction of its thickness. The supportive body 10 is formed with an upper gel room 12 and an under gel room 13, in which the holes 11 communicate the upper and under gel rooms 12 and 13. The profile of each holes 11 is circular or other geometric shaped to correspond to the stress or strain requirement of the composite structure 30. As shown in FIG. 3, the supportive body 10 has a plurality of holes 11 arranged into a honeycomb configuration. The holes 11 include round holes 111 and hexagonal holes 112. The round holes 111 are spaced arranged to form a matrix in which the distance of two adjacent round holes 111 is substantially the width of a hexagonal hole 112, such that each round hole 111 is surrounded by six hexagonal holes 112. In addition, the soft foaming resilient supportive body 10 is compressible, deformable and elastic recoverable, and it is made of PU foaming material, rubber foaming material, EVA foaming material or other material with excellent compressibility and elastic recoverability.

The soft elastomer 20 is filled in the holes 11, and further filled in at least a part of the upper and under gel rooms 12 and 13 respectively. In the present embodiment, the soft elastomer 20 totally encapsulates the supportive body 10, i.e. the soft elastomer 20 is completely filled in the holes 11 and the gel rooms 12 and 13. In addition, the soft elastomer 20 is deformable and elastic recoverable yet substantially incompressible. The soft elastomer 20 is preferably made of PU gel or thermal plastic rubber.

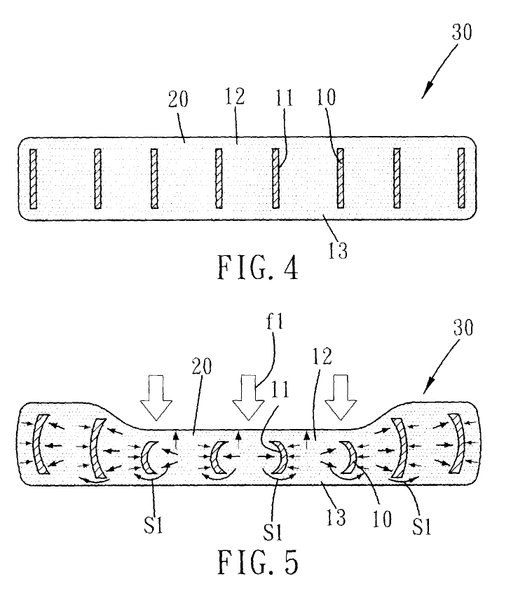

Please refer to FIG. 4. When the soft cushion structure does not load any stress, the soft foaming resilient supportive body 10 is disposed in the soft elastomer 20, and the soft elastomer 20 is, on the other hand, further stuffed in the holes 11 so as to combine the soft elastomer 20 with the supportive body 10 to form a composite structure 30. It is to be noted that the supportive body 10 plays an important role to contribute the stickiness to the composite structure 30, i.e. the supportive body 10 is more supportive than the soft elastomer 20.

Refer to FIG. 5. As a compression stress f1 applies on the composite structure 30 along the axial direction of the holes 11, the soft elastomer 20 provides a stress-strain compensation mechanism due to its property of undergoing a slightly flowing strain. That is to say, the axial strain of the soft elastomer 20 is negative, while the transversal strain thereof is positive. Meanwhile, the soft elastomer 20 which is filled in the hole 11 and the under gel room 13 undergoes a slightly flowing strain S1 and flows into the adjacent holes 11. In other words, the stress-strain compensation mechanism, resulting from the slightly-flowing-strain property, of the soft elastomer 20 can distribute the stress laterally to the other parts of the composite structure 30 which do not directly load the stress, so as to release the pressure efficiently. In addition, the supportive body 10 is also pressed by the compression stress f1 and has a compression strain along the axial direction, and the supportive body 10 also has a sheer strain and a compression strain along the transversal direction due to the lateral pressure distributed by the slightly flowable soft elastomer 20. That is, the supportive body 10 is a structure having a property of undergoing a compression strain and thus has a stress-strain compensation mechanism resulting from such property. It is to be noted that, the soft elastomer 20 itself would have significant deformation along the transversal direction due to the incompressible property thereof. However, due to the displacement of the supportive body 10 within the soft elastomer 20, the transversal deformation of the composite structure 30 as a whole can be efficiently mitigated since the supportive body 10 is compressible and thus has compression strain to counteract the lateral expand of the soft elastomer 20. As a result, even when the soft cushion structure of the present invention is under pressure, the configuration of the composite structure 30 expands just a little. Such characteristic comes in very useful as the soft cushion structure is utilized in a space-limited environment, such as the interior space of a shoe.

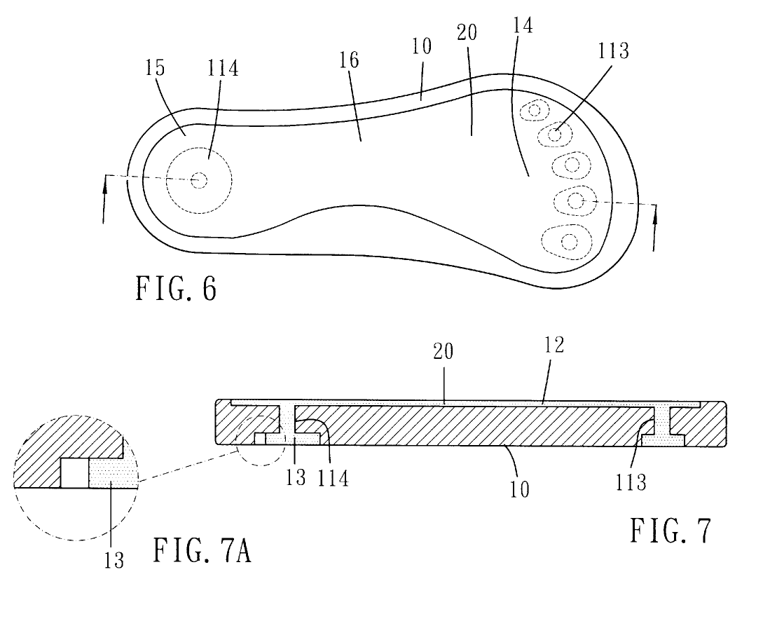

Please refer to FIGS. 6 and 7 for the second embodiment of the present invention. In this embodiment, the soft elastomer 20 substantially corresponds to the configure of the foot, and the supportive body 10 has a thenar portion 14, a heel portion 15 and a connecting portion 16 which connects the thenar and heel portions 14 and 15. The thenar portion 14 has several holes 113 corresponding to the toes, and the heel portion 15 has a larger-diametered hole 114 corresponding to the heel. The soft elastomer 20 covers a main part of the upper surface of the supportive body 10, and the soft elastomer 20 is also completely filled in the holes 113 and 114 and laterally extends into the gel rooms 12 and 13 around the holes 113 and 114. As such, the soft elastomer 20 tightly combines with the supportive body 10 and has sufficient space to enable the slightly flowing strain while being pressed upon. For example, as the user stands on the soft elastomer 20 of the upper gel room 12, the weight of the user will make the soft elastomer 20 of the holes 113 and 114 to flow into the under gel room 13. Meanwhile, lateral pressure is also presented to compress the supportive body 10 to generate a compression strain along the transversal direction. As shown in FIG. 7A, since the under gel room 13 is not fully filled by the soft elastomer 20, a part of the soft elastomer 20 will slightly flow into the unfilled under gel room 13 to further increase the stress releasing effect.

Because the supportive body 10 is more supportive than the soft elastomer 20, the toes and heel of the user will therefore slightly sink into the holes 113 and 114. As such, the upper surface of the soft cushion structure may properly correspond to the curves of the foot. Thus, the arch and heel pain caused by flattening of the foot may be reduced, further minimize the pressure on the spine and strains on the back muscles to relieve lower back pain as well as the stiffness in neck and shoulders.

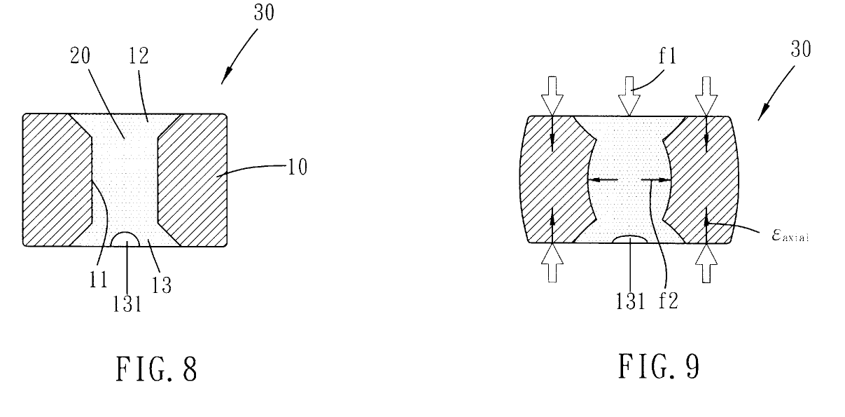

Refer to FIG. 8 for the third embodiment of the present invention. Only one hole 11 is presented on the soft foaming resilient supportive body 10, while the soft elastomer 20 is still filled in the hole 11 and the gel rooms 12 and 13 so as to combine the soft elastomer 20 with the supportive body 10 to form a composite structure 30. The soft elastomer 20, however, does not fully fill the under gel room 13, and a semispherical groove 131 (or other geometric or irregular shaped groove) is left unfilled in the under gel room 13. When the composite structure 30 load a compression stress f1, the soft elastomer 20 generates the slightly flowing strain to function the stress-strain compensation mechanism, and a part of the soft elastomer 20 will be pushed into the unfilled semispherical groove 131 to further release the pressure. Meanwhile, the supportive body 10 generates the compression strain as well as sheer strain to function the stress-strain compensation mechanism thereof, in which the compression strain of the supportive body 10 includes an axial compression strain εₐₓᵢₐₗ caused by the compression stress f1 and a transversal compression strain caused by the transversal pressure f2 which results from the slightly flow of the soft elastomer 20.

In light of the foregoing, the soft cushion structure utilizes the supportive body 10 with better supporting property and a soft elastomer 20, so that the slightly-flowing-strain property of the soft elastomer 20 can co-act with the compression-strain property of the supportive body 10 to enhance the outcome of the stress-strain compensation mechanisms, so as to further elevate the pressure releasing effect. Furthermore, due to the soft elastomer 20 being soft and incompressible and stuffed in the holes that communicate the gel rooms 12 and 13, the soft cushion structure can efficiently distribute the pressure laterally through the slightly flowing strain. As such, the user standing or sitting on the soft cushion structure will feel less fatigue, and the muscle stiffness and oblique posture are therefore ameliorated. Moreover, the displacement of the cheaper and lighter supportive body 10 can reduce the consumption of the expensive soft elastomer 20 so as to significantly reduce the cost and weight of the soft cushion structure of the present invention.

It is to be noted that the soft cushion structure can, besides the above mentioned embodiment, be further used in other fields such as cushion pad of a boxing glove, a sand bag or a saddle. That is, the arrangement of the soft foaming resilient supportive body and the soft elastomer can be varied depending on different needs of the users.

What is claimed is:

1. A soft cushion structure, comprising:
a soft foaming resilient supportive body, having one or more penetrating holes which communicate upper and under gel rooms disposed on the soft foaming resilient supportive body;
a soft elastomer, filled in the holes and at least a part of the upper and under gel rooms respectively, so as to combine the soft elastomer with the soft foaming resilient supportive body to form a composite structure;
wherein the soft foaming resilient supportive body is compressible, deformable and elastic recoverable, the soft elastomer is deformable and elastic recoverable, but the soft elastomer is substantially incompressible.

2. The soft cushion structure of claim 1, wherein the soft elastomer is a structure having a property of undergoing a slightly flowing strain and has a stress-strain compensation mechanism resulting from the property.

3. The soft cushion structure of claim 1, wherein the soft foaming resilient supportive body is a structure having a property of undergoing a compression strain and has a stress-strain compensation mechanism resulting from the property.

4. The soft cushion structure of claim 1, wherein the soft foaming resilient supportive body is made of a rubber foaming material.

5. The soft cushion structure of claim 1, wherein the soft foaming resilient supportive body is made of an EVA foaming material.

6. The soft cushion structure of claim 1, wherein the soft elastomer is made of PU gel.

7. The soft cushion structure of claim 1, wherein the soft elastomer is made of thermal plastic rubber.

8. The soft cushion structure of claim 1, wherein the soft elastomer is completely filled in the upper and under gel rooms.

9. The soft cushion structure of claim 1, wherein each of the holes has a profile being circular or other geometric shaped to correspond to the stress or strain requirement of the composite structure.
